(19) United States
(12) Patent Application Publication
(10) Pub. No.: US 2006/0185396 A1
(43) Pub. Date: Aug. 24, 2006

(54) Device for testing of tempered glass

(76) Inventor: Peter Lisec, Amstetten-Hausmening (AT)

Correspondence Address: YOUNG & THOMPSON, 745 SOUTH 23RD STREET, 2ND FLOOR, ARLINGTON, VA, 22202, US

(21) Appl. No.: 11/182,011

(22) Filed: Jul. 15, 2005

(30) Foreign Application Priority Data
Jul. 15, 2004 (AT) A 1208/2004

(51) Int. Cl. G01N 17/00

(52) U.S. Cl. 65/158; 374/57

(57) ABSTRACT

A device for testing tempered glass plates using a heat-up phase, a holding phase and a cooling phase has at least one chamber in which the glass plates which are to be tested, standing in harp racks, are placed. The device has a fan with a heating and cooling elements which is connected on the intake side to the top end of the chamber and on the pressure side to the bottom end of the chamber underneath a perforated bottom which borders the chamber to the bottom. The perforated bottom can be a stationary, sloped bottom or a conveyor element with a perforated transport belt. Next to the bottom is a discharge channel for glass pellets which form when a glass plate breaks during the test cycle.

Tempered glass which is obtained by heating a glass plate to a temperature above the tempering temperature and quickly cooling it can break into small particle (“pellets” with dimensions on the order of 5 mm) when exposed to thermal loads.

The reasons for this are for example inclusions in the glass, especially metal inclusions (for example, chromium-nickel alloys) which have a coefficient of thermal expansion which is different from that of glass. When the temperature changes, in tempered glass microcracks are formed, especially on the surface and can lead to the tempered glass breaking suddenly, seemingly without external action. Inclusions of metal compounds, for example, nickel sulfide, can result in sudden breaking of tempered glass.

It is therefore provided (draft standard prEN 14179-1:2001) that tempered glass, before it is used or otherwise as it is being used, is tested in a “hot storage process”. To do this the tempered glass plate is heated to a temperature, usually a temperature of roughly 300° C., and kept at this temperature for a long time, usually one to two hours, and then cooled again. If the glass does not break in this testing, it cannot be expected that the tempered glass will break unexpectedly later in use due to inclusions when the temperature changes.

This heating (“heat-up phase”), holding the temperature (“holding phase”) and cooling (“cooling phase”) in the hot storage process are carried out in batches, i.e. the glass panes to be tested are placed in a chamber, heated, the temperature is held and then the plates are cooled. This mode of operation is disadvantageous since it has only low throughput and is associated with considerable energy consumption.

The problem in the known procedure is also that glass pellets which originate from the glass panes which burst during testing damage the test facilities and/or the tempered glass panes to be tested in them.

The object of the invention is to make available a device of the initially mentioned type with which tempered glass can be quickly tested in an energy-saving manner without the indicated disadvantages.

This object is achieved with a device which has the features of claim 1.

Preferred and advantageous embodiments of the invention are the subject matter of the dependent claims.

In the process as claimed in the invention the tempered glass plates to be tested are placed in a chamber in which they are heated to the test temperature, held for the prescribed time at the test temperature, and finally cooled.

Since in the device as claimed in the invention the air flow during heating, holding and cooling is pointed up to emerge through a perforated bottom, energy-saving operation of the device takes place when the tempered glass is being tested.

In one embodiment the perforated bottom is set up in such a way, for example to be sloping at least in one direction, or can be made as a movable, perforated conveyor belt. Thus the glass pellets move away from the bottom and glass particles from glass plates which may have broken do not remain lying on the bottom, but are removed from the bottom so that the air exit openings are not clogged and the testing process can proceed undisturbed.

Advantageously, within the framework of the invention when the bottom is tilted it can be provided that a vibration means is assigned to the bottom in order to support migration of the glass particles into the deepest point of the bottom.

When the bottom of the device as claimed in the invention is made as a perforated conveyor belt, glass pellets are moved away from the conveyor belt by the latter which has been started optionally only when required (fracture of a glass plate) and do not prevent movement (flow) of the gaseous heating medium.

In both embodiments—slanted bottom and perforated conveyor belt as the bottom—there is no danger that glass pellets will be swirled around by the heating and cooling medium and will damage the glass plates or the device itself.

It is advantageous if the glass plates are placed in so-called harp racks in the device as claimed in the invention, moved into the chamber and tested. Such harp racks are known, in connection with which reference is made to U.S. Pat. No. 5,685,437 A. Similar harp racks are known from U.S. Pat. No. 5,209,627 A.

In one embodiment the harp racks are pushed into the chamber from the front.

It is advantageous if in the device as claimed in the invention the bottom is made as a perforated bottom which is made obliquely sloping at least in one direction. This has the advantage that in the case of fracture of a glass plate which is to be tested, the fragments (glass pellets) do not remain lying distributed over the entire bottom, but collect in the area of the lowest point of the bottom.

In the device as claimed in the invention this allows the gaseous fluid which is required to heat the glass plates to move in a circle, and the gaseous fluid required for heating can be supplied underneath the bottom and flows to the top through the bottom. Thus, especially effective heating, effective holding of the temperature and finally effective cooling of the tested glass plates are possible.

In one embodiment it can be provided that on the top of each segment of the chamber there are a fan and a heating device which circulate the gas and for example withdraw it from the chamber from overhead and resupply it to the segments of the chamber on the side and/or underneath the bottom.

At least one chamber can be accessible from the front through doors.

Other details and features of the invention follow from the description below using the schematic drawings which show embodiments of the device as claimed in the invention which is suitable for executing the process as claimed in the invention.

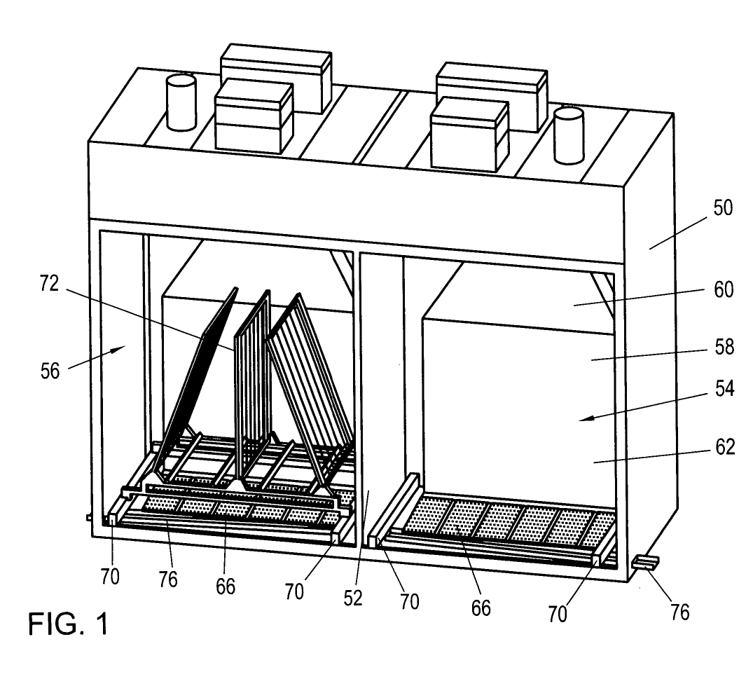

FIG. 1 shows a first embodiment of the device as claimed in the invention in an oblique view and schematically,

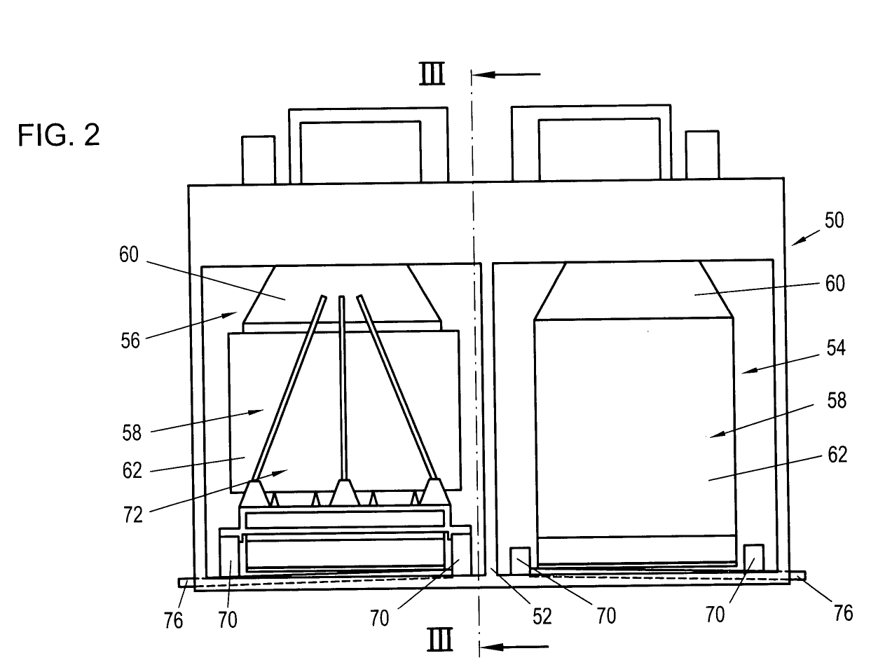

FIG. 2 shows a front view of the device from FIG. 1,

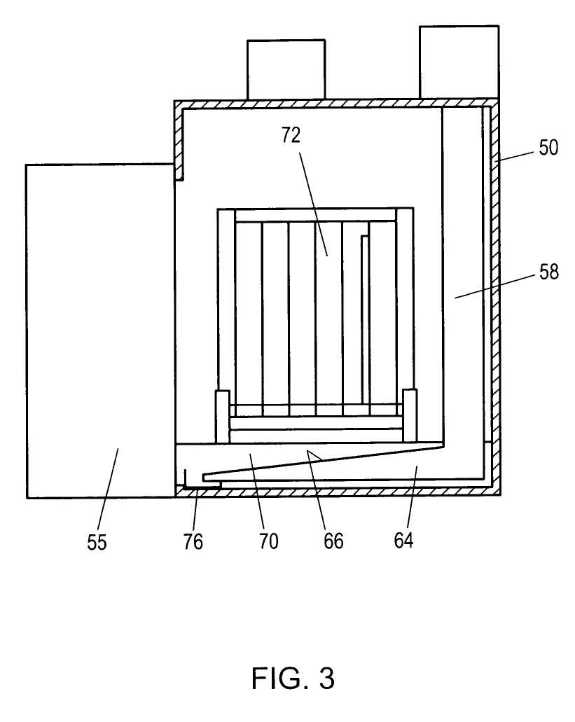

FIG. 3 shows a section along the line 111-111 in FIG. 2 and

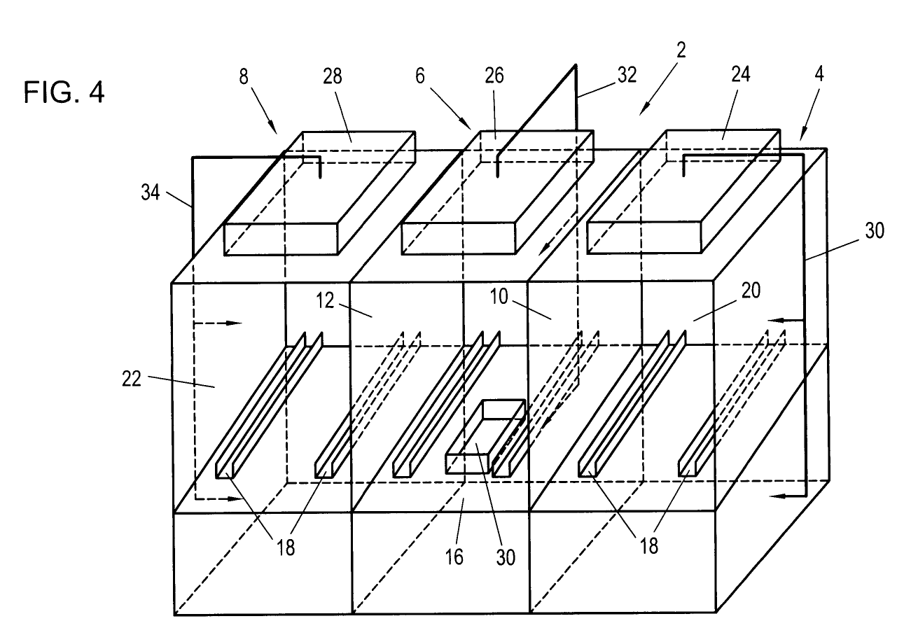

FIG. 4 schematically shows a second embodiment of the device as claimed in the invention.

The embodiment shown in FIG. 4 is explained first.

The device as claimed in the invention consists of a housing 2 which is divided by partitions into three chambers 4, 6, and 8. The partitions 10, 12 between the chambers 4, 6, and 8 can be made as openable doors, for example sliding doors, rolling doors or the like. Each chamber 4, 6, 8 is closed at the bottom by a perforated bottom 16 which is made to slope from the back to the front in the embodiment. In the area of the bottom 16 there are horizontal guide rails 18 for holding the rollers of harp racks (not shown). Harp racks with tempered glass plates to be tested can be pushed into each of the chambers 4, 6, 8 on the guide rails 18 and parked on the rails 18.

Here it is preferred if the harp racks are pushed in such that the tempered glass plates to be tested are aligned in the lengthwise direction of the device, therefore are parallel to the plane of FIG. 1. To do this the front walls 20, 22 of the chambers are made to be openable, for example as a door or the like.

Each chamber 4, 6, 8 is assigned at the top to one fan 24, 26, 28 for withdrawing the gaseous heating or cooling medium (air) which can also be combined with a heating means and with a cooling means. From the fans 24, 26, 28 with the heating means or with the cooling means at least one line 30, 31, 34 at a time proceeds and discharges in the chambers 4, 6, 8 above and especially below the perforated bottom 16.

The bottom 16 which slopes obliquely from back to front is perforated so that heated/cooled gaseous fluid can flow through the bottom 16 from bottom to top into the chambers 4, 6, 8. One embodiment is preferred in which the gaseous fluid which is used for heating, for holding the temperature and for cooling is introduced solely underneath the perforated bottom into the chambers 4, 6, 8 so that is flows up through the perforated bottom 16 and is withdrawn again from the chambers 4, 6, 8 at the top by the fans 24, 26, 28.

If a glass plate should break during the testing process, the particles (glass pellets) of the glass plate will slide down along the bottom 16 to its lowest point, therefore in the embodiment shown to the front edge of the bottom 16. In order to support this movement of fragments, a vibration means 30 can be assigned to the bottom 16 in each chamber 4, 6, 8, as is shown schematically in the drawings for the chamber 6. This has the advantage that fragments of the broken, tempered glass plates do not swirl around and damage other glass plates, especially scratch them, and/or hinder the passage of fluid through the bottom 16. On the front (lowest) edge of the perforated bottom 16 in each chamber 4, 6, 8 there can be a discharge device for glass particles which are formed after a glass plate fractures. It is also possible to provide a single discharge device, for example a channel, which can be made as a vibration conveyor which is common to all chambers 4, 6, 8.

In place of the fixed, stationary bottom 16 there can be a perforated, continuous transport belt in each chamber 4, 6, 8 or only in individual ones of these chambers as a bottom.

This transport belt which can be optionally aligned to slope towards the discharge device (channel) is put into motion such that the glass pellets which form when the glass breaks are moved out of the area of the chamber and fall for example into the discharge device.

Preferably each chamber 4, 6, 8 on its front has an openable door 20, 22 through which harp racks can be pushed in and out or can be placed or removed by fork lifts.

In the device as claimed in the invention there can also be at least one temperature sensor which records the temperature of the glass plates, especially during heating. It is also possible to assign a temperature sensor to each compartment of the harp rack which is designed to hold one glass plate.

The embodiment of a device as claimed in the invention which is shown in FIGS. 1 to 3 is described below.

The embodiment shown in FIGS. 1 to 3 likewise has a housing 50 which is divided by a partition 52 into two chambers 54 and 56. The partition 52 can also be removable so that the device as shown in FIGS. 1 to 3 has a single (large) chamber within the housing 50.

Each chamber 54, 56 on the top end in the area of the upper ceiling wall of the housing 50 is assigned a heating device with a fan which takes air from the upper section of each chamber 54, 56 and sucks it via a heating means which is likewise located in the area of the ceiling wall of the housing 50 and routes it through a channel 58 which has an upper section 60 which widens in a funnel shape and a section with a constant width 62 as far as a lower section 64 which is located underneath the harp racks 72 which have been placed in the chambers 54, 56 with the glass plates to be tested. The section 64 is perforated on its top so that gas which is supplied by the fan can flow out to the top through the “perforated bottom” 66.

On either side of the lower section 64 with its perforated bottom 66 there are rails 70 for holding feet or rollers of harp racks 72.

These harp racks 72 can be pushed on the rails 70 through the opened chambers 54, 56 (the chambers have doors 55 for this purpose, FIG. 3) or can be moved using forklifts or similar transport devices.

On the bottom end of the section 64 with the perforated bottom 66, in each chamber 54, 56 there is a channel 76 which is routed out of the housing 50 and is made sloping so that the glass fragments can be removed which collect in it and which are formed when a tempered glass plate which is to be tested breaks. To support this discharge, vibration means can be assigned to the perforated bottom 66 and/or the channels 76 so that they work in the manner of a vibration conveyor.

In the device as claimed in the invention, in the embodiment of FIGS. 1 to 3 it is first intended that a “test cycle” of the hot storage process consisting of a heat-up phase, holding phase and cooling phase be carried out in each chamber 54, 56. The partition 52 can also be removed in this embodiment. In the embodiment shown in FIGS. 1 to 3 the bottom can be made as a perforated transport belt.

But an operating mode is also considered in that in one of the two chambers 54, 56 the heat-up phase is carried out and at the same time the cooling phase proceeds in the other chamber 56, 54. In this embodiment it can be provided that air be circulated between the chambers 54, 56 so that the air absorbs heat from the glass plates which are to be cooled in one chamber and thus is additionally heated to carry out the heat-up phase in the other chamber.

In summary, one embodiment of the invention can be described as follows:

A device for testing of tempered glass plates using a heat-up phase, a holding phase and a cooling phase has at least one chamber in which the glass plates which are to be tested, standing in harp racks, are placed. The device has a fan with a heating and cooling means which on the intake side is connected to the upper end of the chamber and on the pressure side to the bottom end of the chamber underneath the perforated bottom which borders the chamber to the bottom. The perforated bottom can be a stationary, sloped bottom or a conveyor means with a perforated transport belt. In addition to the bottom, there is a discharge channel for glass pellets which form when a glass plate breaks during the testing cycle. Thus, in any case the glass pellets which may form can be removed from the bottom so that they do not prevent either the emergence of heating/cooling medium through the perforated bottom or are they swirled around by the heating/cooling medium, and in doing so damage the glass plates to be tested and/or the device.

1. Device for testing of tempered glass plates with at least one chamber (4, 6, 8; 54, 56) for accommodating the tempered glass plates to be tested during the heating, holding and cooling phase, characterized in that the chamber (4, 6, 8; 54, 56) has a perforated bottom (16, 66) so that the heated/cooled fluid which is used to heat/cool the glass plates can be routed through this bottom (16, 66) into the chamber (4, 6, 8; 54, 56).

2. Device as claimed in claim 1, wherein the bottom (16, 66) has a discharge means (76) so that the glass fragments which form when one of the glass plates which is to be tested breaks can be moved relative to them.

3. Device as claimed in claim 1 , wherein the bottom (14, 66) is made as a perforated sheet.

4. Device as claimed in claim 3, wherein a vibration means (3) is coupled to the bottom in order to shift the bottom (16, 60) into vibrations (16, 66).

5. Device as claimed in claim 1 , wherein the bottom (16, 66) is made obliquely sloping to one side.

6. Device as claimed in claim 5, wherein the bottom (16, 66) is made obliquely sloping toward the discharge device (76).

7. Device as claimed in claim 1 , wherein the bottom (16) is made as a perforated conveyor belt.

8. Device as claimed in claim 7, wherein a drive is coupled to the perforated conveyor belt and moves the upper strand of the conveyor belt strand in the direction to the discharge device (76).

9. Device as claimed in claim 7 , wherein the perforated conveyor belt is made obliquely sloping toward the discharge device (76).

10. Device as claimed in claim 1 , wherein a fan (24, 26, 28) for circulating fluid through the chamber (4, 6, 8; 54, 56) is connected on the intake side to the top end of the chamber (4, 6, 8; 54, 56) and on the pressure side to the bottom end of the chamber (4, 6, 8; 54, 56).

11. Device as claimed in claim 10, wherein the fan (24, 26, 28) on the pressure side is connected to the chamber (4, 6, 8; 54, 56) at one point underneath the bottom (16, 60).

12. Device as claimed in claim 1 , wherein there is a discharge channel (76) for glass fragments as the discharge device.

13. Device as claimed in claim 12, wherein the discharge channel (76) is located at the lowest point of the bottom (16, 66).

14. Device as claimed in claim 12 , wherein a vibration means is coupled to the discharge channel (76).

15. Device as claimed in claim 1 , wherein there are at least two chambers (4, 6, 8; 54, 56) in the device.

16. Device as claimed in claim 15, wherein there is at least one removable partition (10, 12; 52) between the chambers (4, 6, 8; 54, 56).

17. Device as claimed in claim 11 , wherein the fan (24, 26; 28) is located on the top end of the chamber (4, 6, 8; 54, 56), therefore in the ceiling wall of it.

18. Device as claimed in claim 17, wherein a channel (30, 60) which leads to underneath the perforated bottom (16, 60) proceeds from the fan (24, 26, 28) on the pressure side.
